(19) United States
(12) Patent Application Publication
(10) Pub. No.: US 2019/0022748 A1
(43) Pub. Date: Jan. 24, 2019

(54) Timepiece Part, Timepiece Band, and Timepiece

(71) Applicant: Seiko Epson Corporation, Tokyo (JP)

(72) Inventors: Hiroyuki TAKEMORI, Suwa (JP); Takashi HARA, Suwa (JP)

(21) Appl. No.: 16/040,668

(22) Filed: Jul. 20, 2018

(30) Foreign Application Priority Data
Jul. 21, 2017 (JP) 2017-141720

(51) Int. Cl. B22F 1/00; C22C 1/04

(52) U.S. Cl. CPC B22F 1/0048; G04B 37/22; C22C 1/0458; B22F 1/0059

(57) ABSTRACT

A timepiece part that is configured from sintered metal parts and can improve the appearance, a timepiece band, and a timepiece. A timepiece part made from a sintered metal body, wherein at least a surface of the timepiece part satisfies a specific condition related to a number of holes. By appropriately setting the specific condition, holes are rendered inconspicuous when observing the surface of the timepiece part. As a result, the appearance of the timepiece part can be improved.

### BACKGROUND

### 1. Technical Field

The present invention relates to a timepiece part, a timepiece band, and a timepiece.

### 2. Related Art

Conventionally when making links for a timepiece band, the links are made by cutting deformed wire or repeated forging. The band links are then made by forming holes and polishing the formed parts.

To simplify the manufacturing process, technologies for manufacturing band links from sintered metal bodies manufactured using powder metallurgy methods are known from the literature. See, for example, JP-A-2016-130364.

Because powder metallurgy enables forming parts by press processing using dies, the manufacturing process is simplified compared with methods of making parts by cutting deformed wire or repeated forging steps.

However, because holes (pinholes) can easily result in sintered metal parts when band links and other timepiece parts are made from sintered metal parts, the appearance may be impaired because the holes can be seen even if the surface is polished to a mirror finish to improve the appearance.

### SUMMARY

An object of the present invention is to provide a timepiece part that is configured from sintered metal parts and can improve the appearance, a timepiece band, and a timepiece.

In a timepiece part made from a sintered metal body according to a preferred aspect of the invention, at least a surface of the timepiece part satisfies a specific condition related to a number of holes.

By appropriately setting the specific condition, this aspect of the invention makes holes inconspicuous when the user inspects the surface of the timepiece part, and can therefore improve the appearance of the timepiece part.

In a timepiece part according to another aspect of the invention, when an average of a number of holes per square millimeter is an average count, the specific condition is preferably met when the average count meets a specific count condition.

This aspect of the invention more reliably makes holes inconspicuous, and can improve the appearance of timepiece parts.

In a timepiece part according to another aspect of the invention, when an average of a number of holes per square millimeter is an average count, the specific condition is preferably met when the average count of each type of hole meets a specific count condition set for each type of hole.

The appearance can be further improved by defining the specific condition more stringently (such as reducing the allowable number of holes), but if the specific condition is too stringent, satisfying the specific condition is more difficult, and productivity drops. By setting the specific condition for each type of hole, such as based on the maximum count of the range of non-conspicuity, holes are made harder to see without reducing productivity.

In a timepiece part according to another aspect of the invention, the specific condition is preferably met if the average number of holes of a hole diameter of less than or equal to 10 μm is less than 50.0, the average number of holes of a hole diameter greater than 10 μm and less than or equal to 20 μm is less than 4.0, the average number of holes of a hole diameter greater than 20 μm and less than or equal to 30 μm is less than 0.6, the average number of holes of a hole diameter greater than 30 μm and less than or equal to 40 μm is less than 0.3, the average number of holes of a hole diameter greater than 40 μm and less than or equal to 50 μm is less than 0.1, and the average number of holes of a hole diameter greater than 50 μm is 0.

This aspect of the invention makes holes harder to see without reducing productivity.

In a timepiece part according to another aspect of the invention, the specific condition is preferably met if the specific condition is satisfied to a depth of 150 μm or less from the surface of the timepiece part.

More specifically, this aspect of the invention assures the specific condition is met even if the exposed surface is acquired by polishing the surface of the timepiece part to a depth of 150 μm.

Timepiece parts may be polished to a mirror finish during maintenance to remove scratches, for example. Polishing once to a mirror finish may remove up to approximately 50 μm of material from the surface of the timepiece part.

This aspect of the invention can improve the appearance of the timepiece part even when the timepiece part is twice polished to a mirror finish because the exposed surface continues to meet the specific condition.

In a timepiece part according to another aspect of the invention, the timepiece part preferably has multiple surfaces; and the multiple surfaces satisfy a specific condition that differs according to the surface.

For example, if the timepiece part is a link in a timepiece band, this aspect of the invention enables setting the specific condition met by the surface on the back side of the band that is difficult to see when the timepiece band is worn on the wrist less stringent than the condition that must be met by the face side that is exposed when the band is worn. As a result, productivity can be improved while also improving appearance.

In a timepiece part according to another aspect of the invention, the surface preferably has a mirror finish, a brushed finish, or a satin finish.

The exposed surface of the timepiece part in this aspect of the invention is preferably processed to a mirror finish, a brushed finish, or a satin finish.

This aspect of the invention can also improve the aesthetic design.

In a timepiece part according to another aspect of the invention, the timepiece part is preferably a link of a timepiece band.

The timepiece band is configured from multiple types of band links. The process of manufacturing a timepiece band can therefore be greatly simplified by making the band links from metal sintered bodies, simplifying the band link manufacturing process. This aspect of the invention can therefore simplify manufacturing a timepiece band while also improving the appearance.

Another aspect of the invention is a timepiece band comprising a band link according to the timepiece part of the invention.

This aspect of the invention simplifies manufacturing a timepiece band while also improving the appearance.

Another aspect of the invention is a timepiece having a timepiece band according to the invention.

This aspect of the invention simplifies manufacturing a timepiece while also improving the appearance.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a plan view of a wristwatch according to a preferred embodiment of the invention.

FIG. 2 is a photograph of the mirror surface of a timepiece according to a preferred embodiment of the invention.

### DESCRIPTION OF EMBODIMENTS

A preferred embodiment of the present invention is described below with reference to the accompanying figures.

### Timepiece Configuration

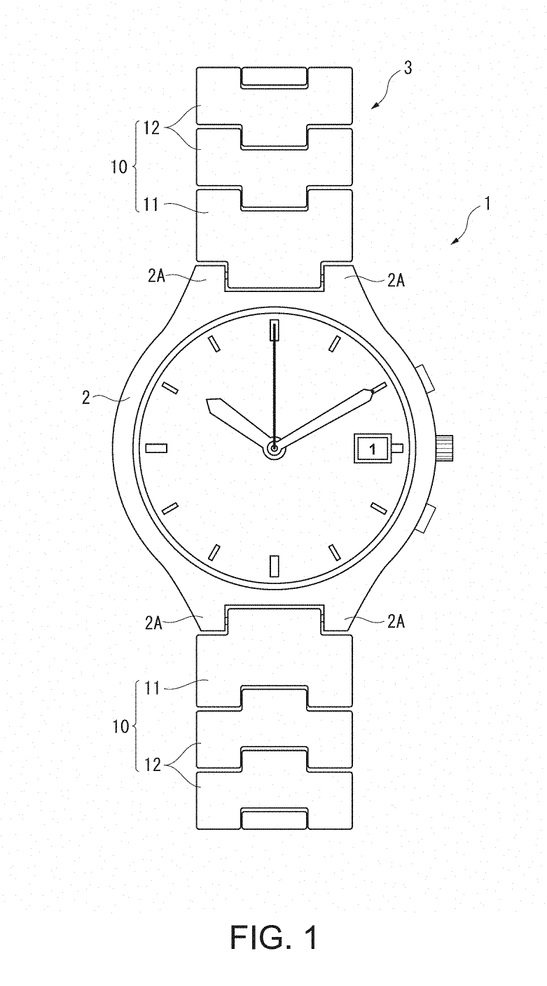

As shown in FIG. 1, a wristwatch 1 described as an example of a timepiece according to the invention has a case 2, and a timepiece band 3.

A pair of lugs 2A is disposed at the 6:00 and 12:00 sides of the case 2. The timepiece band 3 comprises a 6:00-side band connected to the lugs 2A at 6:00 using a spring pin, and a 12:00-side band connected to the lugs 2A at 12:00 using a spring pin, for example. The 6:00-side band and 12:00-side band are joined by a clasp (not shown in the figure).

The band links 10 of the timepiece band 3 include end pieces 11 connected to the lugs 2A of the case 2 by spring pins, and multiple links 12 connected in series from the end pieces 11 by spring pins. Note that the links 12 of the timepiece band 3 may include multiple different kinds of links, such as inside links, outside links, connector links, and adjustment links.

### Band Link Configuration

The band links 10 are manufactured by forming holes through which spring pins pass in high precision sintered metal parts having the desired link shape, and polishing the entire surface of the links to a mirror finish.

The sintered metal parts are made by a powder metallurgy process. More specifically, moldings can be formed to the desired shape by placing a composition of metal powder and binder in a die and applying pressure. The resulting molding is then degreased and sintered.

In this embodiment of the invention, stainless steel (such as SUS 316L) is used for the metal powder. Note that metals other than stainless steel (such as titanium alloys) may be used for the metal powder. In the metal powder sintering process, atomic diffusion occurs within the powders of the metal powder, gradually increasing the density of the moldings until sintered. By optimizing the composition of the metal powder, this embodiment of the invention promotes densification during sintering, and enables producing high density sintered metal parts.

However, holes (pinholes) may be formed between particles of the metal powder in sintered metal parts manufactured in this way, and when the band links 10 are made from such sintered metal parts, the holes may be apparent when viewing the surface of the band links 10, and the appearance may thus be impaired.

As a result, this embodiment of the invention assures the surface of the band links 10 satisfies specific conditions related to the number and diameter of holes that are formed by managing the manufacturing process and quality control process of the band links 10.

More specifically, the surface of the band links 10 satisfies the specific conditions described below.

That is, when the holes are divided into multiple groups based on the hole diameter as shown in Table 1, the average number per square millimeter of holes of each specific diameter must satisfy the specific count condition shown in Table 1. The specific count conditions are set based on the maximum count of the range of non-conspicuity.

TABLE 1

| Hole diameter | Average count |
|---|---|
| ≤10 μm | <50.0 |
| greater than 10 μm and ≤ 20 μm | <4.0 |
| greater than 20 μm and ≤ 30 μm | <0.6 |
| greater than 30 μm and ≤ 40 μm | <0.3 |
| greater than 40 μm and ≤ 50 μm | <0.1 |
| greater than 50 μm | 0 |

The average count per square millimeter is measured as described below.

First, five of the same kind of band link 10 are selected from the band links 10. The measurements described below are then performed on each of the selected band links 10. Specifically, in three random areas each measuring one millimeter square, the diameter and number of the holes are measured. The selected three areas may be on the same surface of the band link 10 (such as the face side of the band), or different surfaces (such as the face side and the back side of the band link). In other words, the diameter and number of the holes are measured in a total of fifteen areas each one millimeter square. The average count per square millimeter is then determined by calculating the average of the numbers.

Table 2 shows an example of the results (number of holes of each hole diameter) of measuring the diameter and number of the holes in three areas of five band links 10, and the relationship to the average count (total number of holes/15). Note that (1) to (3) in the table denote the specific three one-millimeter square areas on the same band link 10.

TABLE 2

| | No. holes | | | No. holes | | | No. holes | | | No. holes | | | No. holes | | | |
|---|---|---|---|---|---|---|---|---|---|---|---|---|---|---|---|---|
| | in link 1 | | | in link 2 | | | in link 3 | | | in link 4 | | | in link 5 | | | Avg. count |
| Hole diameter | (1) | (2) | (3) | (1) | (2) | (3) | (1) | (2) | (3) | (1) | (2) | (3) | (1) | (2) | (3) | (total/15) |
| ≤10 μm | 20 | 23 | 12 | 25 | 52 | 18 | 10 | 15 | 42 | 18 | 15 | 12 | 23 | 20 | 10 | 21.00 |
| greater than 10 μm, ≤20 μm | 1 | 0 | 4 | 3 | 2 | 5 | 2 | 1 | 0 | 3 | 2 | 1 | 0 | 1 | 1 | 1.73 |
| greater than 20 μm, ≤30 μm | 1 | 0 | 0 | 0 | 0 | 1 | 0 | 0 | 0 | 0 | 2 | 0 | 1 | 0 | 0 | 0.33 |
| greater than 30 μm, ≤40 μm | 0 | 0 | 0 | 1 | 0 | 0 | 0 | 0 | 1 | 0 | 1 | 0 | 0 | 0 | 0 | 0.20 |
| greater than 40 μm, ≤50 μm | 0 | 0 | 0 | 0 | 0 | 0 | 0 | 0 | 0 | 0 | 0 | 0 | 0 | 1 | 0 | 0.07 |
| greater than 50 μm | 0 | 0 | 0 | 0 | 0 | 0 | 0 | 0 | 0 | 0 | 0 | 0 | 0 | 0 | 0 | 0.00 |

In the examples in Table 2, the average number of holes of each hole diameter matches the specific condition shown in Table 1, and the band links 10 can therefore be determined to satisfy the specific condition.

Note that if the measured count does not match a specific count, the band links 10 may be determined to not meet the specific condition. Furthermore, if of the five band links 10, the average number of each diameter of hole in the band links 10 other than any single band link 10 meets the specific count condition, those band links 10 may be determined to satisfy the specific condition.

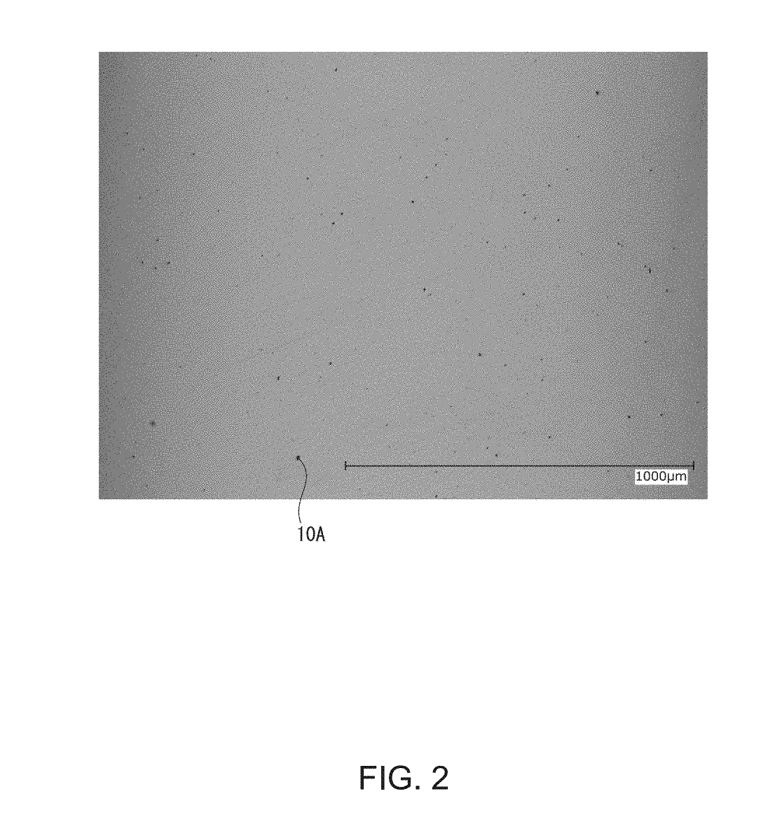

Note that measuring the diameter and number of holes is done using a digital image acquired by digitizing photographed images of mirror finished band links 10 as shown in FIG. 2. Note that point 10A in FIG. 2 indicates a hole.

In addition, the entirety of the band links 10 in this embodiment of the invention meet the specific conditions described above, not only the face side.

### Effect of the Embodiment

Because the surface of the band links 10 in the embodiment described above meets the specific condition, holes are inconspicuous when the user observes the surface of the band links 10. As a result, the appearance of the band links 10, or more specifically the appearance of the timepiece band 3 and the wristwatch 1, can be improved.

The appearance can be further improved by defining the specific condition more stringently (such as reducing the allowable number of holes), but if the specific condition is too stringent, satisfying the specific condition is more difficult, and productivity drops. Because the specific condition is met if the specific count condition defined in Table 1 is met in this embodiment, holes are made harder to see without reducing productivity.

Furthermore, the entirety of the band links 10 satisfy the specific condition described above, and not just the face side. As a result, even if the surface is polished during maintenance to remove scratches, the appearance can be improved because the exposed surface satisfies the specific condition.

### Other Embodiments

The invention is not limited to the embodiments described above, and can be modified and improved in many ways without departing from the scope of the accompanying claims.

In the embodiment described above, the band links 10 satisfy the specific condition in entirety, but the invention is not so limited. More specifically, only the face side of the band links 10 may satisfy the specific condition.

However, the part of the surface of the band links 10 to a depth of 150 μm or less preferably meets the specific condition. The band links 10, which are part of a timepiece, may be polished during maintenance to remove scratches. For example, a first polishing of the band links 10 may remove material to approximately 50 μm. The configuration described above can improve the appearance because the exposed surface satisfies the foregoing specific condition even if polished twice.

In the embodiment described above all surfaces of the band links 10 are polished, but the invention is not so limited. For example, only one surface of the band, such as the exposed face of the band, may be polished. Furthermore, all or part of the surface of the band links 10 may be finished to a brushed finish or satin finish, for example.

This embodiment of the invention uses band links 10 as an example of a timepiece part, but the invention is not so limited. The timepiece part may be the case 2, a buckle or clasp, or a bezel, for example.

However, a timepiece band 3 comprises multiple types of band links 10. As a result, the process of manufacturing a timepiece band 3 can be greatly simplified by making the band links 10 from sintered metal moldings, simplifying production of the band links 10.

Furthermore, the specific condition is considered met if the average number of holes of each specific diameter meets the specific count conditions shown in Table 1, but the invention is not so limited. The specific condition may be changed according to the type of timepiece part. For example, the specific may be met when the specific count condition is set, independently of the hole diameter, and the average count calculated based on all holes meets the specific count condition.

Furthermore, whether or not the surface of the band links 10 satisfies the specific condition is determined in the foregoing embodiment by comparing the average number of holes in five band links 10 with the specific count conditions shown in Table 1, but the invention is not so limited. More specifically, the decision may be based on comparing the average number of holes in four or fewer band links 10 with the specific count condition.

Furthermore, when measuring the average count in the embodiment described above, the number of holes is counted in three or more areas one millimeter square in each of the band links 10, but the invention is not so limited. More specifically, the holes may be measured in only one or two areas one millimeter square.

Furthermore, the embodiment described above determines if multiple surfaces (the surface on the face side of the band, the surface on the back side of the band, and the side surfaces) of the band links 10 satisfy a common specific condition, but the invention is not so limited. For example, the multiple surfaces may be required to meet specific conditions that differ according to the surface. For example, the specific condition met by the surface on the back side that is not seen when the timepiece band 3 is worn on the wrist may be less strict than the condition met by the surface on the face side of the band. In addition, of the side surfaces, the specific condition met by the difficult-to-see surfaces of adjacent band links 10 may be less strict than the condition met by the other side surfaces of the band. A configuration in which only some surfaces, such as the surface on the face side of the band, satisfy the specific condition is also conceivable. As a result, productivity can be improved while also improving the appearance.

The invention being thus described, it will be obvious that it may be varied in many ways. Such variations are not to be regarded as a departure from the spirit and scope of the invention, and all such modifications as would be obvious to one skilled in the art are intended to be included within the scope of the following claims.

The entire disclosure of Japanese Patent Application No. 2017-141720, filed Jul. 21, 2017 is expressly incorporated by reference herein.

What is claimed is:

1. A timepiece part made from a sintered metal body, wherein:
at least a surface of the timepiece part satisfies a specific condition related to a number of holes.

2. The timepiece part described in claim 1, wherein:
when an average of a number of holes per square millimeter is an average count,
the specific condition is met when the average count meets a specific count condition.

3. The timepiece part described in claim 1, wherein:
when an average of a number of holes per square millimeter is an average count,
the specific condition is met when the average count of each type of hole meets a specific count condition set for each type of hole.

4. The timepiece part described in claim 3, wherein:
the specific condition is met if
the average number of holes of a hole diameter of less than or equal to 10 μm is less than 50.0,
the average number of holes of a hole diameter greater than 10 μm and less than or equal to 20 μm is less than 4.0,
the average number of holes of a hole diameter greater than 20 μm and less than or equal to 30 μm is less than 0.6,
the average number of holes of a hole diameter greater than 30 μm and less than or equal to 40 μm is less than 0.3,
the average number of holes of a hole diameter greater than 40 μm and less than or equal to 50 μm is less than 0.1, and
the average number of holes of a hole diameter greater than 50 μm is 0.

5. The timepiece part described in claim 1, wherein:
the specific condition is met if the specific condition is satisfied to a depth of 150 μm or less from the surface of the timepiece part.

6. The timepiece part described in claim 1, wherein:
the timepiece part has multiple surfaces; and
the multiple surfaces satisfy a specific condition that differs according to the surface.

7. The timepiece part described in claim 1, wherein:
surface has a mirror finish, a brushed finish, or a satin finish.

8. The timepiece part described in claim 1, wherein:
the timepiece part is a link of a timepiece band.

9. A timepiece band comprising a link of a timepiece band according to the timepiece part described in claim 8.

10. A timepiece comprising a timepiece band described in claim 9.
